(19) United States
(12) Patent Application Publication
(10) Pub. No.: US 2008/0214770 A1
(43) Pub. Date: Sep. 4, 2008

(54) Silane-Modified Urea Derivatives, Method For the Production Thereof, and Use Thereof as Auxiliary Rheologicla Agents

(76) Inventors: Stefan Ingrisch, Truchtlaching (DE); Gerhard Albrecht, Tacherting (DE); Stefan Thaler, Trostberg (DE); Mathias Bauer, Trostberg (DE)

Correspondence Address: FULBRIGHT & JAWORSKI, LLP, 666 FIFTH AVE, NEW YORK, NY, 10103-3198, US

(21) Appl. No.: 11/916,471

(22) PCT Filed: Jun. 30, 2006
(86) PCT No.: PCT/EP2006/006387

§ 371 Date: Dec. 4, 2007

(30) Foreign Application Priority Data
Jul. 1, 2005 (DE) 10 2005 030 828.7

(51) Int. Cl. C08G 18/02; C08G 18/04

(52) U.S. Cl. 528/74.5

(57) ABSTRACT

The invention describes amphiphilic polymer compounds which have been prepared by
a) reacting a di-, tri- or tetraglycidyl compound (A) with an optionally unsaturated reactive component (B) consisting of C₈-C₂₈-fatty acid, a C₈-C₂₈-alcohol or a secondary C₈-C₂₈-amine, and then
b) allowing the reaction product from stage a) to react with an aliphatic or aromatic polyisocyanate compound (C) and finally
c) reacting the reaction product from stage b) with a polyalkylene oxide compound (D) of the general formula (I)

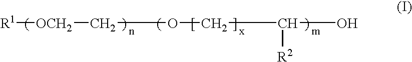

in which
R¹ is H or a linear or branched and optionally unsaturated aliphatic hydrocarbon radical having 1 to 12 C atoms,
R2 is a linear or branched and optionally unsaturated aliphatic hydrocarbon radical having 1 to 30 C atoms or phenyl,
m is from 0 to 250, n is from 3 to 350 and x is from 1 to 12,
   and the ethylene oxide or higher alkylene oxide units can be arbitrarily distributed in the polyalkylene oxide compound (D).

The polymer compounds proposed in accordance with the invention are exceptionally suitable as agents for preventing or suppressing efflorescence on surfaces of cured, hydrometrically settable building materials and/or for hydrophobization of the corresponding hydraulically settable systems. Moreover, owing to the admixtures proposed in accordance with the invention, the corresponding products absorb substantially less water, with the result that frost damage and rapid rusting of the steel reinforcement can be substantially reduced.

The present invention relates to amphiphilic polymer compounds, a method for the production thereof and their use as an admixture for hydraulically settable building materials (such as, for example, concrete or mortar) which is used in particular for mass hydrophobization and/or for suppression of efflorescence on surfaces of hardened, hydraulically settable building materials.

A known problem, particularly in the case of cement-based building materials, is the occurrence of so-called efflorescence, a distinction being made between primary and secondary efflorescence. The first-mentioned arises as early as during hardening, for example in the case of concrete, the capillaries of the fresh concrete being filled with an aqueous solution of the water-soluble substances of the cement, substantially calcium hydroxide. On hardening, the calcium hydroxide on the concrete surface reacts with the carbon dioxide of the air with formation of sparingly soluble calcium carbonate. As a result of the precipitation of calcium carbonate, the calcium hydroxide concentration at the capillary mouth is lower than in the interior of the capillaries. Fresh calcium hydroxide therefore continuously diffuses from the deeper layers of the concrete to the capillary mouth and in turn reacts with CO₂ to give calcium carbonate. The corresponding process stops only when the capillary mouths are closed by calcium carbonate. Such primary efflorescence occurs in a particularly pronounced manner when a condensation film forms on the concrete surface, because the calcium hydroxide can then become distributed over the entire concrete surface and coat this with water-insoluble calcium carbonate after the reaction with carbon dioxide.

In addition, the outdoor weathering of completely hardened concrete can result in spot formation, which is generally referred to as secondary efflorescence. This secondary efflorescence lasts as a rule from 1 to 2 years, the slow formation of water-soluble calcium bicarbonate from calcium carbonate being regarded as a cause.

Since the appearance of such structural elements associated with efflorescence is very greatly impaired, particularly in the case of colored concrete products, there has been no lack of attempts to prevent or to suppress this efflorescence by various measures.

According to the prior art, two basic possibilities were proposed for this purpose, none of which, however, have led to satisfactory results. Firstly the surfaces of hardened cement or concrete products are provided with special coatings, especially various silicate and acrylate coatings having been recommended. However, the fact that these subsequent coatings are relatively inconvenient and uneconomical is disadvantageous in this method.

For this reason, attempts have been made to add suitable additives to the building materials prior to the curing thereof, which additives are intended to prevent or suppress the formation of efflorescence.

Thus, DE 32 29 564 A1 discloses the use of additional chalk, for example in the form of an aqueous chalk slurry, in the production of colored pre-cast concrete blocks. This is intended to shift the gradient of formation of calcium carbonate to the surface by offering excess calcium carbonate right at the beginning of the solidification process.

Finally, according to EP 92 242 A1, it is proposed to add surface-active polymers to the concrete for preventing efflorescence. These surface-active polymers should lose their surface activity irreversibly during the hardening of the concrete and should thus be converted into water-insoluble products.

In practice, such water repellants for unhardened building materials have not become established since they do not have a reliable effect under the various weathering conditions.

It was therefore the object of the present invention to provide agents for the prevention of efflorescence on surfaces of hardened, hydraulically settable building materials and/or for mass hydrophobization, which agents do not have the said disadvantages of the prior art but effectively and reliably prevent the efflorescence of hydraulically settable building materials. This object was achieved, according to the invention, by the provision of amphiphilic polymer compounds which have been prepared by

a) reacting a di-, tri- or tetraglycidyl compound (A) with an optionally unsaturated reactive component (B) consisting of C8-C₂₈-fatty acid, a C₈-C₂₈-alcohol or a secondary C₈-C₂₈-amine, and then

b) allowing the reaction product from stage a) to react with an aliphatic or aromatic polyisocyanate compound (C), and finally

c) reacting the reaction product from stage b) with a polyalkylene oxide compound (D) of the general formula (I)

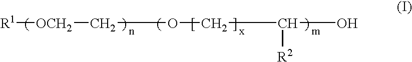

in which

R¹ is H or a linear or branched and optionally unsaturated aliphatic hydrocarbon radical having 1 to 12 C atoms,

R² is a linear or branched and optionally unsaturated aliphatic hydrocarbon radical having 1 to 30 C atoms or phenyl,

m is from 0 to 250,

n is from 3 to 350 and

x is from 1 to 12,

and the ethylene oxide or higher alkylene oxide units can be arbitrarily distributed in the polyalkylene oxide compound (D).

It has surprisingly been found here that these polymer compounds are excellently suitable as agents for preventing efflorescence and/or for hydrophobization of hydraulically settable building materials. Moreover, owing to the admixtures according to the invention, the hydraulically settable products absorb substantially less water, with the result that frost damage and rapid rusting of the steel reinforcement can be substantially reduced.

The amphiphilic polymer compounds according to the invention are obtainable by a three-stage method comprising the reaction steps a), b) and c).

In the first reaction stage a), a di-, tri- or tetraglycidyl compound (A) is reacted with a reactive component (B).

Glycidyl compounds which are selected from the group cyclohexanedimethanol diglycidyl ether, glyceryl triglycidyl ether, neopentylglycol diglycidyl ether, pentaerythrityl tetraglycidyl ether, 1,6-hexanediol diglycidyl ether, polypropylene glycol diglycidyl ether, polyethylene glycol diglycidyl ether, tetramethylolpropane triglycidyl ether, bisphenol A diglycidyl ether, bisphenol F diglycidyl ether, 4,4′-methylenebis(N,N-diglycidylaniline), tetraphenyl-olethane glycidyl ether, N,N-diglycidylaniline, diethylene glycol diglycidyl ether, 1,4-butanediol diglycidyl ether, or mixtures thereof are particularly advantageously used.

It is also to be regarded as being essential to the invention that the reactive component (B) consists of a C₈-C₂₈-fatty acid, C₈-C₂₈-alcohol or a secondary C₈-C₂₈-amine, it being possible for the reactive component to have saturated or unsaturated radicals.

From the group consisting of the fatty acids, tall oil fatty acid, stearic acid, palmitic acid, sunflower oil fatty acid, coconut oil fatty acid (C₈-C₁₈), coconut oil fatty acid (C₁₂-C₁₈), soybean oil fatty acid, linseed oil fatty acid, dodecanoic acid, oleic acid, linoleic acid, palm kernel oil fatty acid, palm oil fatty acid, linolenic acid and/or arachidonic acid are to be regarded as being preferred. In the case of the C₈-C₂₈-alcohols, 1-eicosanol, 1-octadecanol, 1-hexadecanol, 1-tetradecanol, 1-dodecanol, 1-decanol and 1-octanol have proven particularly useful. In the case of the secondary amines having C8-C₂₈ C atoms in particular the alkylamines from the group consisting of 2-ethylhexylamine, dipentylamine, dihexylamine, dioctylamine, bis(2-ethylhexyl)amine, N-methylocta-decylamine and didecylamine are used.

The molar ratio of glycidyl components (A) to the reactive component (B) can be varied within wide limits, but it has proven particularly advantageous to use from 0.9 to 1.1 mol of the reactive component (B) per mole of the glycidyl groups of component (A).

In the second reaction stage b), the reaction product from stage a) is allowed to react with an aliphatic or aromatic polyisocyanate compound (C).

Preferably used aliphatic polyisocyanate compounds are 1-isocyanato-5-isocyanatomethyl-3,3,5-trimethylcyclohexane (IPDI), bis(4-isocyanato-cyclohexyl)methane (H12MDI), 1,3-bis(1-isocyanato-1-methylethyl)benzene (m-TMXDI), 1,6-diisocyanatohexane (HDI), optionally the higher homologs thereof or industrial isomer mixtures of the individual aliphatic polyisocyanates, while preferably used aromatic polyisocyanates are in particular 2,4-diisocyanatotoluene (TDI), bis(4-isocyanato-phenyl)methane (MDI) and optionally the higher homologs thereof (polymeric MDI) or industrial isomer mixtures of the individual aromatic polyisocyanates.

According to a preferred embodiment, the polyisocyanate compound is used in an amount such that the NCO/OH equivalent ratio, based on the free OH group in the reaction product of glycidyl component (A) and the reactive component (B) from stage a), is from 0.5 to 2.0.

In the following reaction stage c), the reaction product from reaction stage b) is reacted with a polyalkylene oxide compound (B) of the general formula (I).

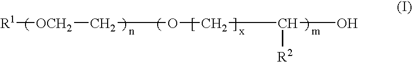

### Here,

R¹ is H or a linear or branched and optionally unsaturated aliphatic hydrocarbon radical having 1 to 12 C atoms,

R² is a linear or branched and optionally unsaturated aliphatic hydrocarbon radical having 1 to 30 C atoms or phenyl,

m is from 0 to 250,

n is from 3 to 350 and

x is from 1 to 12,

and the ethylene oxide or higher alkylene oxide units can be arbitrarily distributed in the polyalkylene oxide compound (D).

It has proven particularly advantageous if the polyalkylene oxide compound (D) is used in an amount of from 0.9 to 1.1 mol per mole of free isocyanate groups of the reaction product in stage b).

The reaction of the glycidyl compound (A) with the reactive component (B) according to stage a) has been sufficiently described according to the prior art. Thus, the reaction of epoxides with carboxylic acids is described in “Reaktionen der organischen Synthese [Reactions of organic synthesis]”, Cesare Ferri, 1st edition 1978, page 505, and in “Methoden der organischen Chemie [Methods of organic chemistry]”, Houben-Weyl, 4th edition, volume 6/3, page 459, and volume 14/2, pages 507 to 510. Regarding the reaction of epoxides with alcohols, reference may be made to “Methoden der organischen Chemie [Methods of organic chemistry]”, Houben-Weyl, 4th edition, volume 6/3, pages 40 to 44 and pages 456 to 458, and volume 14/2, pages 503 to 506, and to “Reaktionen der organischen Synthese [Reactions of organic synthesis]”, Cesare Ferri, 1st edition 1978, page 505. The reaction of epoxide with amines is disclosed, for example, in “Methoden der organischen Chemie [Methods of organic chemistry]”, Houben-Weyl, 4th edition, volume 14/2, pages 516 to 523, and in “Reaktionen der organischen Synthese [Reactions of organic synthesis]”, Cesare Ferri, 1st edition 1978, pages 504 to 505.

The reaction of the glycidyl component (A) with the reactive component (B) is preferably effected at temperatures of from 20 to 250° C., it being possible for the reaction optionally to be effected in the presence of a catalyst. Thus, it has proven particularly advantageous to resort to basic catalysts, for example, tetraalkylammonium halides or alkali metal oxides, in the reaction of the glycidyl component (A) with the fatty acid as reactive component (B). In the case of the reaction of the glycidyl component (A) with an alcohol as reactive component (B), the reaction can be carried out either under acid catalysis (e.g. sulfuric acid, perchloric acid, hydrofluoric acid, boron trifluoride, tin(IV) chloride) or under base catalysis (e.g. alkali metal hydroxides, alkali metal alcoholates, tertiary amines).

The reaction of the glycidyl component (A) with the secondary amines as reactive component (B) is effected as a rule without a catalyst, but small amounts of water or alcohol (e.g. phenol) can be added to the reaction mixture.

The reaction of the reaction product from stage a) with the polyisocyanate component (C) according to reaction stage b) is preferably effected without solvent at temperatures of from 20 to 120° C., according to a preferred embodiment the polyisocyanate component (C) being initially introduced and the reaction product from stage a) being continuously added.

The reaction stage c) regarding the reaction of the reaction product from stage b) with the polyalkylene oxide compound (D) is preferably likewise carried out without a solvent in the temperature range from 20 to 120° C.

The polymer compounds proposed according to the invention are outstandingly suitable for the mass hydrophobization of hydraulically settable building materials and/or for suppressing efflorescence on the surface of hardened, hydraulically settable building materials. Here, the polymer compounds are added to the mixed and unhardened, hydraulically settable building materials in an amount of from 0.01 to 5% by weight, based on the proportion of binder. All concrete and mortar systems which contain cement or cement substitutes, such as, for example, silica dust, blast furnace slack or fly ash, as the main binder and optionally also lime, gypsum or anhydrite as a secondary constituent are to be regarded as hydraulically settable building materials according to the present invention. However, it is also possible for calcium sulfate in the form of, for example, gypsum, anhydrite or hemihydrate to be used as the main binder and cement, silica dust, blast furnace slag or fly ash to be used as the secondary constituent.

However, it is also possible within the scope of the present invention for the admixtures according to the invention to be added to the mixing water or residual water in emulsified form with the aid of external emulsifiers (for example ethoxylated compounds, such as fatty acid ethoxylate, ethoxylated castor oil or ethoxylated fatty amine).

The polymer compounds proposed according to the invention are outstandingly suitable as agents for the prevention or suppression of efflorescence on surfaces of hardened hydraulically settable building materials and/or for the hydrophobization of the corresponding cement-containing systems.

Moreover, as a result of the admixtures proposed according to the invention, the hydraulically settable products absorb substantially less water, with the result that frost damage and rapid rusting of the reinforcement steel can be substantially reduced.

The following examples are intended to illustrate the invention in more detail.

### EXAMPLES

### Example 1

Initially introduce 629.8 g (2.1717 mol) of tall oil fatty acid (from Hanf & Nelles) into the reaction vessel at room temperature, add 369.2 g (1.0859 mol) of bisphenol A diglycidyl ether (trade name: Polypox E 270/500; from UPPC) and then add 1.0 g (0.0031 mol) of tetrabutylammonium bromide (from Aldrich). The reaction space is flushed with nitrogen and the reaction mixture is heated to 150° C. This temperature is maintained until an acid number of <2 is reached.

Duration of reaction: about 8 h.

### Example 1A

32.2 g of (0.1849 mol) of toluene diisocyanate (TDI; from Aldrich) are initially introduced into the reaction vessel at room temperature and 4 drops of T12-DBTL (catalyst; from Aldrich) are added. Heat the initially introduced mixture in the reaction vessel to 30° C. and meter in 85.0 g (0.0924 mol) of the fatty acid adduct from example 1 over about 60 min. The reaction temperature is kept at 40-50° C. After complete addition of the fatty acid adduct from example 1, allow the reaction to continue until the theoretical NCO value for this stage (6.62% by weight) is reached. Once the theoretical NCO value has been reached, 92.4 g (0.1848 mol) of MPEG 500 (trade name: Polyglycol M 500; from Clariant) are metered in. The reaction temperature is kept at 50-60° C.

After complete addition of the MPEG 500, stirring is continued at 50-60° C. until the NCO value has fallen to zero. The reaction product is mixed with 1187.7 g of tap water with thorough stirring until the homogeneous yellowish turbid dispersion (solids content 15% by weight) forms.

### Example 1B

Initially introduce 80 g (0.0870 mol) of the fatty acid adduct from example 1 into the reaction vessel at room temperature and add 4 drops of T12-DBTL (catalyst: from Aldrich). Heat the initially introduced mixture in the reaction vessel to 60° C. and meter in 20.1 g (0.1154 mol) of toluene diisocyanate (TDI; from Aldrich) over about 60 min. The reaction temperature is kept at 60-70° C. After complete addition of the toluene diisocyanate, the reaction is allowed to continue until an NCO value of 2.42% by weight is reached. 114.8 g (0.0574 mol) of MPEG 2000 (trade name Polyglycol M 2000; from Clariant) are then metered in over about 60 min. The reaction temperature is kept at 60-70° C. Stirring is continued until the NCO value has fallen to zero. The reaction product is mixed with 1217.8 g of tap water with thorough stirring until a homogeneous orange turbid dispersion (solids content 15% by weight) forms.

### Example 1C

300 g (0.3261 mol) of fatty acid adduct from example 1 are initially introduced into the reaction vessel at room temperature and 4 drops of T12-DBTL (catalyst; from Aldrich) are added. Heat the initially introduced mixture in the reaction vessel to 60° C. and meter in 28.4 g (0.1631 mol) of toluene diisocyanate (TDI; from Aldrich) over about 60 min. The reaction temperature is kept at 60-70° C. The NCO/OH ratio for this reaction is 0.50. After complete addition of the toluene diisocyanate, stirring is continued at 60-70° C. until the NCO value has fallen to zero. The reaction product is a pale brown viscous liquid. 60 g of a fatty acid ethoxylate (trade name: Ethylan A3; from AkzoNobel) are initially introduced into the reaction vessel and heated to 55° C. Thereafter, 120 g of the above reaction product is heated to 55° C. and added to the initially introduced mixture over 1 h. A brownish white viscous mixture forms. 620 g of water are then metered in over 1 h. Finally, a milky white dispersion having a solids content of 15% by weight, based on the above reaction product, is obtained.

### Example 2

Initially introduce 631.8 g (2.2524 mol) of sunflower oil fatty acid (from Hanf & Nelles) into the reaction vessel at room temperature, and 367.2 g (0.5632 mol) of pentaerythrityl tetraglycidyl ether (trade name: Polypox R16; from UPPC) and then add 1.0 g (0.0031 mol) of tetrabutylammonium bromide (from Aldrich). The reaction space is flushed with nitrogen and the reaction mixture is heated to 150° C. This temperature is maintained until an acid number of <2 is reached. Duration of reaction: about 10 h.

### Example 2A

Initially introduce 62.83 g (0.3608 mol) of toluene diisocyanate (TDI; from Aldrich) into the reaction vessel at room temperature and add 4 drops of T12-DBTL (catalyst from Aldrich). Heat the initially introduced mixture in the reaction vessel to 30° C. and meter in 160.0 g (0.0902 mol) of the fatty acid adduct from example 2 over about 60 min. The reaction temperature is kept at 30-40° C. After complete addition of the fatty acid adduct from example 2, allow the reaction to continue until the theoretical NCO value for this stage (6.80% by weight) is reached. Once the theoretical NCO value has been reached, 92.4 g (0.1848 mol) of MPEG 500 (trade name: Polyglycol M 500; from Clariant) are metered in. The reaction temperature is kept at 40-50° C. After complete addition of the MPEG 500, stirring is continued at 50-60° C. until the NCO value has fallen to zero. The reaction product is mixed with 1187.7 g of tap water with thorough stirring until a homogeneous brownish turbid dispersion (solids content 15% by weight) forms.

### Example 3

Initially introduce 666.0 g (2.2966 mol) of tall oil fatty acid (from Hanf & Nelles) into the reaction vessel at room temperature, and 333.0 g (0.7655 mol) of trimethylolpropane triglycidyl ether (trade name: Polypox R20; from UPPC) and then add 1.0 g (0.0031 mol) of tetrabutylammonium bromide (from Aldrich). The reaction space is flushed with nitrogen and the reaction mixture is heated to 150° C. This temperature is maintained until an acid number of <2 is reached. Duration of reaction: about 9 h.

### Example 3A

Initially introduce 57.5 g (0.2298 mol) of 4,4′-diphenylmethane diisocyanate (MDI; from Aldrich) into the reaction vessel at 50° C. and add 4 drops of T12-DBTL (catalyst from Aldrich). Keep the initially introduced mixture in the reaction vessel at 50° C. and meter in 100.0 g (0.0766 mol) of the fatty acid adduct from example 3 over about 60 min. The reaction temperature is kept at about 60° C. After complete addition of the fatty acid adduct from example 3, allow the reaction to continue until the theoretical NCO value for this stage (6.13% by weight) is reached. Once the theoretical NCO value has been reached, 114.9 g (0.2298 mol) of MPEG 500 (trade name: Polyglycol M 500; from Clariant) are metered in. The reaction temperature is kept at 60-70° C. After complete addition of the MPEG 500, stirring is continued at 60-70° C. until the NCO value has fallen to zero. The reaction product is mixed with 1543.6 g of tap water with thorough stirring until a homogeneous orange turbid dispersion (solids content 15% by weight) forms.

### Example 4

Initially introduce 643.4 g (2.2938 mol) of sunflower oil fatty acid (from Hanf & Nelles) into the reaction vessel at room temperature, and 355.6 g (1.1471 mol) of neopentylglcyol diglycidyl ether (trade name: Polypox R14; from UPPC) and then add 1.0 g (0.0031 mol) of tetrabutylammonium bromide (from Aldrich). The reaction space is flushed with nitrogen and the reaction mixture is heated to 150° C. This temperature is maintained until an acid number of <2 is reached.

Duration of reaction: about 8 h.

### Example 4A

Initially introduce 160.0 g (0.1837 mol) of the fatty acid adduct from example 4 into the reaction vessel at 50° C. and add 4 drops of T12-DBTL (catalyst; from Aldrich). Keep the initially introduced mixture in the reaction vessel at 50° C. and meter in ⅓ (16.0 g; 0.0919 mol) of the amount of toluene diisocyanate (TDI; from Aldrich) over about 40 min. The reaction temperature is kept at 50-60° C. After addition of the 1st amount of toluene diisocyanate, allow the reaction to continue until the NCO value has fallen to zero. The remaining ⅔ (32.0 g; 0.1837 mol) of the amount of toluene diisocyanate are then added in one portion. The reaction temperature is kept at 60-70° C. and the reaction is allowed to continue until the theoretical NCO value for this stage (3.71% by weight) is reached. Thereafter, 367.4 g (0.3674 mol) of MPEG 1000 (trade name: Polyglycol M 1000; from Clariant) are metered in over 60 min and the temperature is kept at 60-70° C. Stirring is continued until the NCO value has fallen to zero.

The reaction product is mixed with 2310.2 g of tap water with thorough stirring until a homogeneous, milky yellow dispersion (solids content 15% by weight) forms.

### Example 4B

Initially introduce 55.5 g (0.2500 mol) of isophorone diisocyanate (IPDI; from Aldrich) into the reaction vessel at room temperature and add 4 drops of T12-DBTL (catalyst; from Aldrich). Heat the initially introduced mixture in the reaction vessel to 45° C. and meter in 250.0 g (0.2500 mol) of MPEG 1000 (trade name: Polyglycol M 1000; from Clariant) over about 60 min. The reaction vessel is kept at 40-50° C. After complete addition of the MPEG 1000, allow the reaction to continue until the theoretical NCO value for this stage (3.44% by weight) is reached. Once the theoretical NCO value has been reached, 217.8 g (0.2500 mol) of the fatty acid adduct from example 4 are added in one portion. The reaction temperature is kept at 50-60° C. Stirring is then continued until the NCO value has fallen to zero. The reaction product is mixed with 2965.4 g of tap water with thorough stirring until a homogeneous, yellowish, almost clear solution (solids content 15% by weight) forms.

### Example 4C

304.85 g (0.3500 mol) of fatty acid adduct from example 4 are initially introduced into the reaction vessel at room temperature and 4 drops of T12-DBTL (catalyst; from Aldrich) are added. Heat the initially introduced mixture in the reaction vessel to 60° C. and meter in 40.64 g (0.2333 mol) of toluene diisocyanate (TDI; from Aldrich) over about 60 min. The reaction temperature is kept at 60-70° C. The NCO/OH ratio for this reaction is 0.66. After complete addition of the toluene diisocyanate, stirring is continued at 60-70° C. until the NCO value has fallen to zero. The reaction product is a pale brown viscous liquid. 60 g of an ethoxylated castor oil (trade name: Berol 199; from AkzoNobel) are initially introduced into the reaction vessel and heated to 55° C. Thereafter, 120 g of the above reaction product are heated to 55° C. and added to the initially introduced mixture over 1 h. A brownish white, viscous mixture forms. 620 g of water are then metered in over 1 h. A milky white dispersion having a solids content (15% by weight), based on the above reaction product, is finally obtained.

### Example 5

Initially introduce 605.9 g (2.1601 mol) of sunflower oil fatty acid (from Hanf & Nelles) into the reaction vessel at room temperature, and 393.1 g (1.0799 mol) of bisphenol A diglycidyl ether (trade name: Araldit GY 240; from Huntsman) and then add 1.0 g (0.0031 mol) of tetrabutylammonium bromide (from Aldrich). The reaction space is flushed with nitrogen and the reaction mixture is heated to 150° C. This temperature is maintained until an acid number of <2 is reached.

Duration of reaction: about 8 h.

### Example 5A

300 g (0.3243 mol) of fatty acid adduct from example 5 are initially introduced into the reaction vessel at room temperature and 4 drops of T12-DBTL (catalyst; from Aldrich) are added. Heat the initially introduced mixture in the reaction vessel to 60° C. and meter in 28.2 g (0.1622 mol) of toluene diisocyanate (TDI; from Aldrich) over about 60 min. The reaction temperature is kept at 60-70° C. The NCO/OH ratio for this reaction is 0.50. After complete addition of the toluene diisocyanate, stirring is continued at 60-70° C. until the NCO value has fallen to zero. The reaction product is a pale brown, viscous liquid. 60 g of an ethoxylated castor oil (trade name: Berol 199; from AkzoNobel) are initially introduced into the reaction vessel and heated to 55° C. Thereafter, 120 g of the above reaction product is heated to 55° C. and added to the initially introduced mixture over 1 h. A brownish white, viscous mixture forms. 620 g of water are then metered in over 1 h. A milky white dispersion having a solids content of 15% by weight, based on the above reaction product, is finally obtained.

### Example 5B

Initially introduce 92.5 g (0.1000 mol) of the fatty acid adduct from example 5 into the reaction vessel at room temperature and add 4 drops of T12-DBTL (catalyst; from Aldrich). Heat the initially introduced mixture in the reaction vessel to 60° C. and meter in 29.6 g (0.1333 mol) of isophorone diisocyanate (IPDI; from Aldrich) over about 60 min. The reaction temperature is kept at 60-70° C. After complete addition of the toluene diisocyanate, the reaction is allowed to continue until an NCO value of 2.29% is reached. 133.3 g (0.0667 mol) of MPEG 2000 (trade name Polyglycol M 2000; from Clariant) are then metered in over about 60 min. The reaction temperature is kept at 60-70° C. Stirring is continued until the NCO value has fallen to zero. The reaction product is mixed with 1447.3 g of tap water with thorough stirring until a homogeneous, orange turbid dispersion (solids content 15% by weight) forms.

### Testing of the Products Produced

The test specimens are produced by the following method and tested for their efflorescence behavior:

In accordance with the standard, a mixture (11 kg) is produced according to the following formulation in a positive mixer, all aggregates first being dry-mixed for 10 sec. Thereafter, the initial water is added and mixing is effected for 2 min, after which the remaining water is added (duration of mixing 2 min). The admixture is added to the remaining water:

| 380 kg/m³ | Cement (Bernburg CEM I 42.5 R; 380 kg/m³) |
|---|---|
| 1104 kg/m³ | Sand 0/2 |
| 296 kg/m³ | Gravel 2/5 |
| 296 kg/m³ | Gravel 5/8 |
| 137 kg/m³ | Water |
| w/c: | 0.36 |

The admixture is used in different doses, based on the cement in the mixture, and is added either to the remaining water or to the concrete mix. The data on the metering of the admixture are always based on solid “admixture” to solid “cement”. The water content of the admixture is subtracted from the amount of mixing water.

For the production of the test specimens, in each case exactly 1300 g of the fresh concrete mix is introduced into round molds and compacted with an applied weight 30 kg on a vibrating table for 90 sec. Thereafter, the fresh test specimen is removed from the mold and stored for 2 days in a conditioned chamber (20° C., 65% relative humidity) for hardening. The lightness of the test specimens is then measured using a color photospectrometer (Color-Guide sphere spin, Byk Gardner) (L1), a template having 9 measuring points being placed on the test specimens so that the same points can be measured later on in the 2nd measurement. The mean value L1 is obtained from these 9 points.

Thereafter, the blocks are immersed in distilled water for about 2 sec and packed air tight in a plastic bag while moist. This bag is stored in the conditioned chamber for 10 days. Thereafter, the blocks are unpacked and are stored in the conditioned chamber for 2 days for drying. The lightnesses of the test specimens are now measured a 2nd time using the template and color photospectrometer (L2). 6 test specimens are prepared per mix (and the mean value calculated therefrom). The color change of the surface (ΔL) of the test specimens (increase in whiteness) is: ΔL=L2−L1.

In addition to the lightening (ΔL) of the test specimens due to the efflorescence, the homogeneity of the surface was also assessed, and the water absorption of the test specimens was determined.

Determination of the water absorption (WA) based on EN ISO 15148: The dry and hardened test specimens are weighed (W1) and placed in a water bath so that the under side rests on the point supports and does not touch the container bottom. The water level is about 5 mm above the highest point of the underside. After 15 min, the test specimens are removed from the water bath and weighed a 2nd time (W2). The test specimen is dried beforehand with a moist sponge which has been rung out. The water absorption is: WA=W2−W1.

TABLE 1
(Accelerated efflorescence in the condition
chamber, 20° C., 65% relative humidity)

| | Dose | Lightness | | Assessment |
|---|---|---|---|---|
| | [% by | difference | Water absorption | of the |
| Example | weight] | ΔL | WA [g] | surface |
| 1 A | 0.25 | 0.8 (7.9) −90% | 3.5 (58.0) −94% | satisfactory |
| | 0.10 | 0.9 (7.9) −89% | 4.0 (58.0) −93% | satisfactory |
| 1 B | 0.25 | 0.7 (7.9) −91% | 3.2 (58.0) −94% | satisfactory |
| | 0.10 | 0.9 (7.9) −89% | 3.5 (58.0) −94% | satisfactory |
| 1 C | 0.25 | 0.9 (7.9) −89% | 3.2 (58.0) −94% | satisfactory |
| | 0.10 | 1.0 (7.9) −87% | 3.7 (58.0) −94% | satisfactory |
| 2 A | 0.25 | 0.9 (9.0) −90% | 4.3 (52.7) −92% | satisfactory |
| | 0.10 | 1.0 (9.0) −89% | 4.8 (52.7) −91% | satisfactory |
| 3 A | 0.25 | 0.8 (8.2) −90% | 3.9 (48.3) −92% | satisfactory |
| | 0.10 | 0.9 (8.2) −89% | 5.0 (48.3) −90% | satisfactory |
| 4 A | 0.25 | 0.8 (8.7) −91% | 2.9 (51.1) 94% | satisfactory |
| | 0.10 | 0.9 (8.7) −90% | 3.2 (51.1) −94% | satisfactory |
| 4 B | 0.25 | 0.7 (8.7) −92% | 2.5 (51.1) −95% | satisfactory |
| | 0.10 | 0.9 (8.7) −90% | 3.0 (51.1) −94% | satisfactory |
| 4 C | 0.25 | 0.9 (8.7) −90% | 2.2 (51.1) −96% | satisfactory |
| | 0.10 | 1.1 (8.7) −87% | 2.5 (51.1) −95% | satisfactory |
| 5 A | 0.25 | 0.9 (7.8) −88% | 2.6 (54.7) −95% | satisfactory |
| | 0.10 | 1.0 (7.8) −87% | 3.0 (54.7) −95% | satisfactory |
| 5 B | 0.25 | 0.8 (7.8) −90% | 2.9 (54.7) −95% | satisfactory |
| | 0.10 | 1.0 (7.8) −87% | 3.3 (54.7) −94% | satisfactory |

The values in brackets are the results of the zero mixes (without admixture). The percentage values indicate the extent to which the admixture has reduced the lightness of the water absorption in each case in comparison with the zero mix (without admixture).

The dosage indicates the solids of the admixture, based on cement in the mixture.

1-15. (canceled)

16. An amphiphilic polymer compound which have been prepared by the process of
a) reacting a di-, tri- or tetraglycidyl compound (A) with an optionally unsaturated reactive component (B) consisting of C₈-C₂₈-fatty acid, a C₈-C₂₈-alcohol or a secondary C₈-C₂₈-amine, and then
b) allowing the reaction product from stage a) to react with an aliphatic or aromatic polyisocyanate compound (C) and finally
c) reacting the reaction product from stage b) with a polyalkylene oxide compound (D) of the general formula (I) 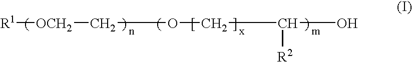
in which
R¹ is H or a linear or branched and optionally unsaturated aliphatic hydrocarbon radical having 1 to 12 C atoms,
R² is a linear or branched and optionally unsaturated aliphatic hydrocarbon radical having 1 to 30 C atoms or phenyl,
M is from 0 to 250,
N is from 3 to 350 and
X is from 1 to 12,
and the ethylene oxide or higher alkylene oxide units can be arbitrarily distributed in the polyalkylene oxide compound (D).

17. The polymer compound as claimed in claim 16, wherein component (A) is at least one glycidyl compound selected from the group consisting of cyclohexanedimethanol diglycidyl ether, glyceryl triglycidyl ether, neopentyl glycol diglycidyl ether, pentaerythrityl tetraglycidyl ether, 1,6-hexanediol diglycidyl ether, polypropylene glycol diglycidyl ether, polyethylene glycol diglycidyl ether, trimethylolpropane triglycidyl ether, bisphenol A diglycidyl ether, bisphenol F diglycidyl ether, 4,4′-methylenebis(N,N-diglycidylaniline), tetraphenylolethane glycidyl ether, N,N-diglycidylaniline, diethylene glycol diglycidyl ether, and 1,4-butanediol diglycidyl ether.

18. The polymer compound as claimed in claim 16, wherein reactive component (B) is a fatty acid selected from a fatty acid from the group consisting of oil fatty acid, stearic acid, palmitic acid, sunflower oil fatty acid, coconut oil fatty acid (C₈-C₁₈), coconut oil fatty acid (C₁₂-C₁₈), soybean oil fatty acid, linseed oil fatty acid, dodecanoic acid, oleic acid, linoleic acid, palm kernel oil fatty acid, palm oil fatty acid, linolenic acid and arachidonic acid.

19. The polymer compound as claimed in claim 16, wherein reactive component (B) is an alkanol selected from the group consisting of group 1-eicosanol, 1-octadecanol, 1-hexadecanol, 1-tetradecanol, 1-dodecanol, 1-decanol and 1-ocatanol.

20. The polymer compound as claimed in claim 16, wherein reactive component (B) is a dialkylamine an selected from the group consisting of 2-ethylhexylamine, dipentylamine, dihexylamine, dioctylamine, bis(2-ethylhexyl)amine, N-methyloctadecylamine and didecylamine.

21. The polymer compound as claimed in claim 16, wherein from 0.9 to 1.1 mol of the reactive component (B) is present per mole of the glycidyl groups of component (A).

22. The polymer compound as claimed in claim 16, wherein the aliphatic polyisocyanate is 1-isocyanato-5-isocyanatomethyl-3,3,5-trimethylcyclohexane (IPDI), bis(4-isocyanatocyclohexyl)methane (H12MDI), 1,3-bis( 1-isocyanato-1-methylethyl)benzene (m-TMXDI), 1,6-diisocyanatohexane (HDI), a higher homolog thereof or an industrial isomer mixture of the individual aliphatic polyisocyanate.

23. The polymer compound as claimed in claim 16, wherein the aromatic polyisocyanate is 2,4-diisocyanatotoluene (TDI), bis(4-isocyanatophenyl)methane (MDI), a higher homolog thereof (polymeric MDI) or an industrial isomer mixture of the individual aromatic polyisocyanates.

24. The polymer compound as claimed in claim 16, wherein the polyisocyanate compound is present in an amount such that the NCO/OH equivalent ratio, based on the free OH group in the reaction product of glycidyl component (A) and reactive component (B) from stage a), is from 0.5 to 2.0.

25. The polymer compound as claimed in claim 16, wherein in formula (I) relating to the polyalkylene oxide compound (B), R is —CH₃, CH═CH₂— or CH₂═CH—CH₂—.

26. The polymer compound as claimed in claim 16, wherein the polyalkylene oxide compound (D) is present in an amount of from 0.9 to 1.1 mol per mole of free isocyanate groups of the reaction product in stage b).

27. A method for the production of a polymer compound as claimed in claim 16, wherein
a) the glycidyl component (A) is reacted with the reactive component (B) at temperatures of from 20 to 250° C., optionally in the presence of an acidic or basic catalyst,
b) the reaction product from stage a) is allowed to react further with a polyisocyanate component (C) without a solvent in the temperature range from 20 to 120° C., and finally
c) the reaction product from stage b) is reacted with the polyalkylene oxide compound (D) likewise without a solvent at temperatures of from 20 to 150° C.

28. An hydraulically settable building material containing the polymer compound of claim 16.

29. The material of claim 29, wherein the polymer compound is present in an amount to suppress efflorescence on a surface of a hardened, hydraulically settable building material.

30. The material of claim 28, wherein the polymer compound is present in an amount of from 0.001 to 5% by weight, based on the proportion of binder.
